(19) United States
(12) Patent Application Publication
(10) Pub. No.: US 2008/0063307 A1
(43) Pub. Date: Mar. 13, 2008

(54) Pixel Interpolation

(75) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,547

(22) PCT Filed: Jun. 17, 2005
(86) PCT No.: PCT/IB05/52002

§ 371 Date: Dec. 13, 2006

(30) Foreign Application Priority Data
Jun. 22, 2004 (EP) 04102912.5

(51) Int. Cl. G06K 9/60

(52) U.S. Cl. 382/300

(57) ABSTRACT

An interpolation unit (800) for computing an output pixel value of an output pixel of an output image on basis of input pixel values of a set of input pixels (101-114) being selected from an input image is disclosed. The interpolation unit (800) comprises: input pixel selection means (802) for selecting the input pixels, comprising a first group of pixels (101-107) and a second group of pixels (108-114); and order statistical filtering means (804) for determining the output pixel value on basis of the set of input pixels (101-114). The set of input pixels is characterized in that lines (115, 116) connecting pairs of input pixels (103, 113) being formed by respective input pixels of the first group of pixels (101-107) and the second group of pixels (108-114) intersect at a position (100) in the particular input image corresponding to a position in the output image where the output pixel is located.

The invention relates to an interpolation unit for computing an output pixel value of an output pixel of an output image on basis of input pixel values of a set of input pixels being selected from a number of input images, which is odd.

The invention further relates to an image processing apparatus comprising:

receiving means for receiving an image signal representing images; and

an interpolation unit as described above.

The invention further relates to a method of interpolation by computing an output pixel value of an output pixel of an output image on basis of input pixel values of a set of input pixels being selected from a number of input images, which is odd.

The invention further relates to a computer program product to be loaded by a computer arrangement, comprising instructions to interpolate an output pixel value of an output pixel of an output image on basis of input pixel values of a set of input pixels being selected from a number of input images, which is odd.

The combination of television standards inertia and display equipment innovation results in an increasing demand for algorithms for the conversion of interlaced video to progressively scanned signals, i.e. de-interlacing. A single optimal de-interlacing algorithm does not exist; rather, various algorithms are designed to suit a wide variety of computational and financial budgets. The algorithms that offer the highest image quality adapt the interpolation to the maximum correlation found in either the spatial dimension or in the temporal dimension. In the spatial dimension, the algorithm may adapt to the edge orientation, while in the temporal domain motion adaptivity or motion compensation have been proposed. See the article “De-interlacing—An overview”, by G. de Haan and E. B. Bellers, in Proceedings of the IEEE, Vol. 86, No. 9, Sep. 1998, pp. 1839-1857.

Even though the interplay between spatial and temporal de-interlacing algorithms is critical for the best possible image quality, in practice design constraints may rule out a motion compensated or motion adaptive algorithm as too expensive or otherwise inappropriate. In many cases, therefore, de-interlacing is solely based on the, by definition, spatial information contained in the single odd or even field that is to be de-interlaced. In this sub-class of spatial de-interlacing algorithms, edge-dependent algorithms are a further sub-category.

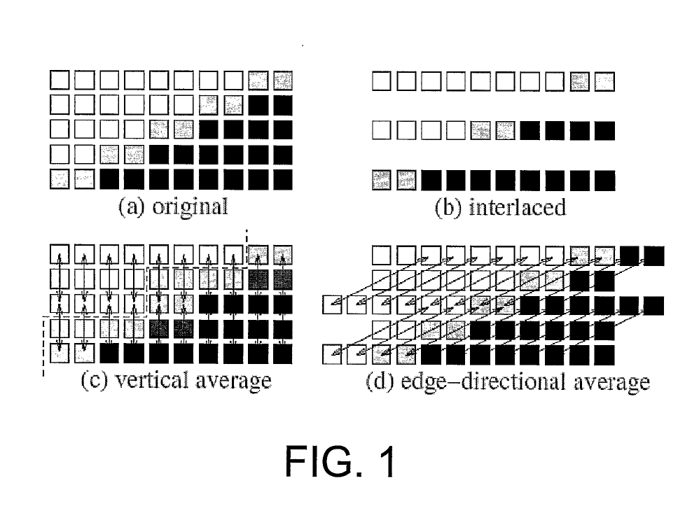

In a spatial algorithm only one field, representing 50% of the total information, is available. As the video signal contains vertical frequencies above the Nyquist limit, it is impossible to reliably interpolate missing information. The best option in this case is to interpolate the missing values in the direction in which the signal is most stationary. As FIGS. 1a-d illustrate, it is best to interpolate along edges in the image. In this case, a simple vertical interpolation results in an unpleasant “staircase” effect. See dashed line in FIG. 1c.

It is an object of the invention to provide a new interpolation unit of the kind described in the opening paragraph that is robust and relatively easy to implement.

This object of the invention is achieved in that the interpolation unit comprises:

input pixel selection means for selecting the input pixels, comprising a first group of pixels and a second group of pixels, whereby lines connecting pairs of input pixels being formed by respective input pixels of the first group of pixels and the second group of pixels intersect at a position in a particular input image, corresponding to a position in the output image where the output pixel is located; and

order statistical filtering means for determining the output pixel value on basis of the set of input pixels.

That means that the input pixels which are provided to the order statistical filtering means are selected in a particular way. In literature, an order statistical filter is also called a rank-order filter. The input pixels of the set of input pixels are located around said position in the particular input image. Said position in the particular input image spatially matches with the position of the output pixel. For each of the pixels of the set, i.e. each pixel of the first group, there is a counterpart pixel, i.e. a respective pixel of the second group. The lines connecting the pixels of the first group with the respective pixels of the second group intersect at said position in the particular input image. Typically, but not exclusive, a first distance between a first pixel of the first group and said position and a second distance between the counterpart pixel of the first pixel of the first group and said position are mutually equal. In that case the first pixel of the first group and its counterpart pixel are symmetrically located around said position.

The particular composition of the set of input pixels in combination with the order statistical filtering of the selected pixels results in an edge dependent interpolation. In other words, the order statistical filtering provides as output an output pixel value which matches relatively well with luminance structures, like edges in the input images. An advantage of the interpolation unit according to the invention is that without expensive computations, e.g. for evaluating a number of edge orientations, an appropriate output pixel value is determined.

With odd is meant any number being equal to 1,3,5,7,9, . . . etcetera. In the case that the number of input images is equal to 1, the interpolation is a spatial filtering. In the case that the number of input images is higher than 1, the interpolation is a so-called spatial temporal filtering. Typically, the particular input image is temporally located in the center of the input images.

In this specification the focus is on de-interlacing, i.e. a number of embodiments which are disclosed in this specification are related to de-interlacing. However the interpolation unit, the method and the computer program product according to the invention can also be applied to general interpolation techniques for spatial scaling, in particular spatial up scaling. In de-interlacing the concepts of fields and frames are known. A field comprises the odd or even video lines, i.e. rows of a frame. In this specification with an image is meant either a field or a frame.

An embodiment of the interpolation unit according to the invention comprises a weighted median filter. That means that the input samples of the order statistical filtering means, which are copies of the input pixel values, are weighted. For some of the input pixels there are multiple copies and for others there is only a single copy provided. Preferably, the output of the filtering means, i.e. the output pixel value of the output pixel, is equal to the selected one of the input pixel values. Alternatively, the output of the filtering means is computed by taking a weighted average of a number of selected input pixel values. The interpolation weighting factors to be used for computing the weighted average typically differ from the selection weighting factors to be used for creating the set for input samples of the filtering means.

Preferably, the selection weighting factors are related to distances. For example a first one of the pairs of input pixels which is located relatively close to said position in the particular input image has a relatively high weight compared to a second one of the pairs of input pixels which is located relatively far from said position in the particular input image.

In an embodiment of the interpolation unit according to the invention, the first group of pixels are selected from a first row of the particular input image which is located above said position in the particular input image and the second group of pixels are selected from a second row of the particular input image which is located below said position in the particular input image. This embodiment according to the invention is in particular suitable for de-interlacing. Then, the first group of pixels and the second group of pixels are selected from two succeeding even video lines or succeeding odd video lines. The output pixel belongs to the video line (odd/even) which is located in between these two video lines.

Preferably, the output of the interpolation unit according to the invention is further processed by an image conversion unit as specified in U.S. application Ser. No. 10/639421 as filed at Aug. 5, 2003 by the same applicant on basis of an invention of G. de Haan and E. Bellers (Attorney Docket number PHNL030931).

In an embodiment of the interpolation unit according to the invention the set of input pixels comprises further input pixels being selected from a previous input image being temporally preceding the particular input image and from a next input image being temporally succeeding the particular input image. Preferably, besides input pixels being selected from the particular input image, the set of input pixels also comprises further input pixels which are selected from other input images. Typically, the input previous image, the particular input image and the next input image are part of a sequence of video images. As said above, an image in the context of this specification may be a field or a frame. The point of intersection, i.e. said position, is a point in the multidimensional space. So an input pixel which is selected from the previous input image has its counterpart pixel in the next input image. The line connecting these two pixels intersects with other of such connecting lines at said position. Taking temporal input pixels is advantageous for the robustness of the interpolation unit.

An embodiment of the interpolation unit according to the invention is arranged to compute the output pixel value by computing an average of a first output of a first order statistical filter and a second output of a second order statistical filter. This embodiment according to the invention is advantageous for de-interlacing. Preferably, the selection of input samples and statistical filtering is as follows:

input of the first order statistical filter comprises a first one of the pixels of the first group of pixels, a first one of the pixels of the second group of pixels and a first one of the pixels of the first row of the previous input image; and

input of the second order statistical filter comprises the first one of the pixels of the first group of pixels, the first one of the pixels of the second group of pixels and a first one of the pixels of the first row of the next input image.

Preferably, the first one of the pixels of the first row of the previous image and the first one of the pixels of the first row of the next image are symmetrically located around said position. Preferably, the first order statistical filter is a first three-tap median filter and the second order statistical filter is a second three-tap median filter. The selection of the temporal input pixels, i.e. from the previous input image and the next input image are selected on basis of a minimization of an error criterion.

It is a further object of the invention to provide an image processing apparatus of the kind described in the opening paragraph that is robust and relatively easy to implement.

This object of the invention is achieved in that the interpolation unit of the image processing apparatus comprises:

input pixel selection means for selecting the input pixels, comprising a first group of pixels and a second group of pixels, whereby lines connecting pairs of input pixels being formed by respective input pixels of the first group of pixels and the second group of pixels intersect at a position in a particular input image, corresponding to a position in the output image where the output pixel is located; and

order statistical filtering means for determining the output pixel value on basis of the set of input pixels.

It is a further object of the invention to provide a method of the kind described in the opening paragraph that is robust and relatively easy to implement.

This object of the invention is achieved in the method comprises:

selecting the input pixels, comprising a first group of pixels and a second group of pixels, whereby lines connecting pairs of input pixels being formed by respective input pixels of the first group of pixels and the second group of pixels intersect at a position in a particular input image, corresponding to a position in the output image where the output pixel is located; and

determining the output pixel value by order statistical filtering the set of input pixels.

It is a further object of the invention to provide a computer program product of the kind described in the opening paragraph that is robust and relatively easy to implement.

This object of the invention is achieved in that the computer arrangement, comprising processing means and a memory, after being loaded, provides said processing means with the capability to carry out:

selecting the input pixels, comprising a first group of pixels and a second group of pixels, whereby lines connecting pairs of input pixels being formed by respective input pixels of the first group of pixels and the second group of pixels intersect at a position in a particular input image, corresponding to a position in the output image where the output pixel is located; and

determining the output pixel value by order statistical filtering the set of input pixels

Modifications of the interpolation unit and variations thereof may correspond to modifications and variations thereof of the image processing apparatus, the method and the computer program product, being described.

These and other aspects of the interpolation unit, of the image processing apparatus, of the method and of the computer program product, according to the invention will become apparent from and will be elucidated with respect to the implementations and embodiments described hereinafter and with reference to the accompanying drawings, wherein:

FIG. 1a-d schematically show the effects of vertical averaging and edge directional averaging;

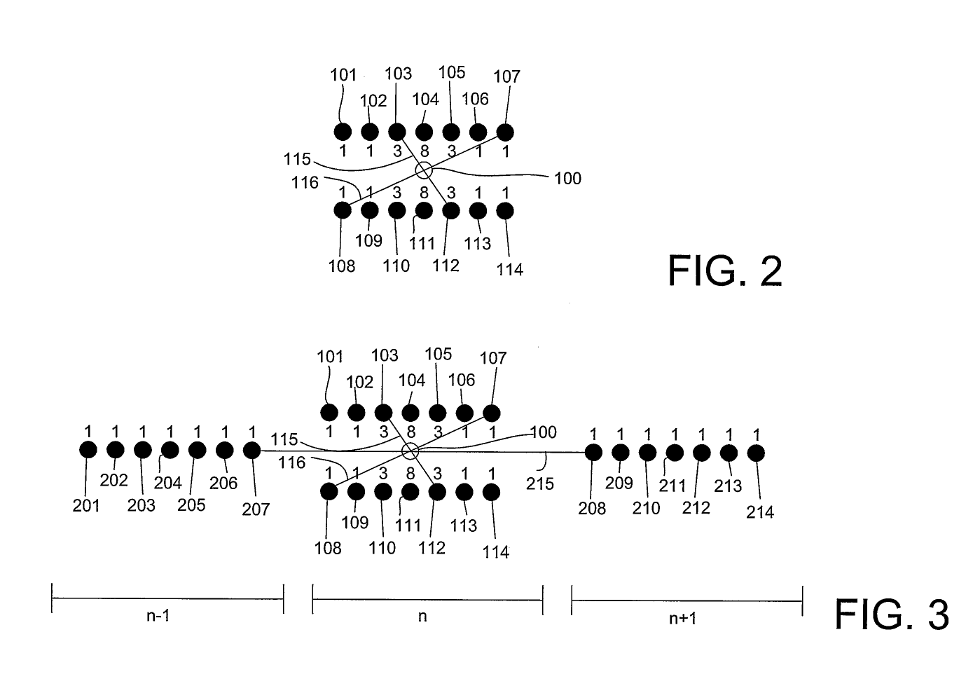

FIG. 2 schematically shows a selection of input pixels of a single input image, according to the invention;

FIG. 3 schematically shows a selection of input pixels of three consecutive input images according to the invention;

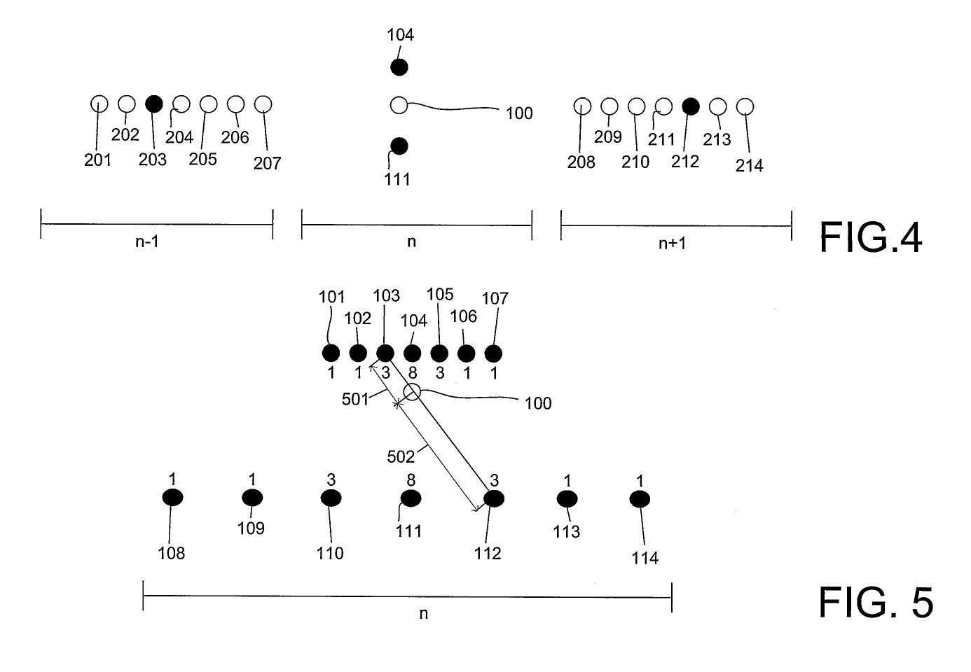

FIG. 4 schematically shows a selection of input pixels on basis of minimization of an error criterion;

FIG. 5 schematically shows a selection of input pixels of a single input image, whereby a first distance between a first input pixel and the point of intersection and a second distance between the counterpart input pixel and the point of intersection are mutually different;

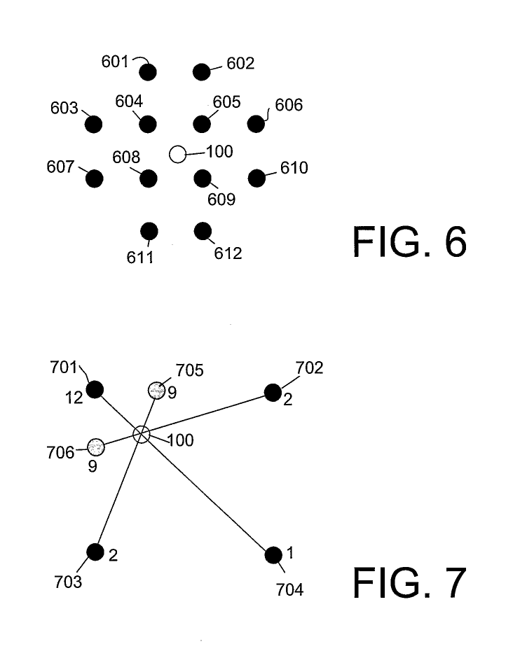

FIG. 6 schematically shows a further selection of input pixels according to the invention;

FIG. 7 schematically shows a selection of input samples whereby a number of samples are copies of input pixels and another number of samples are computed by means of averaging further copies of input pixels;

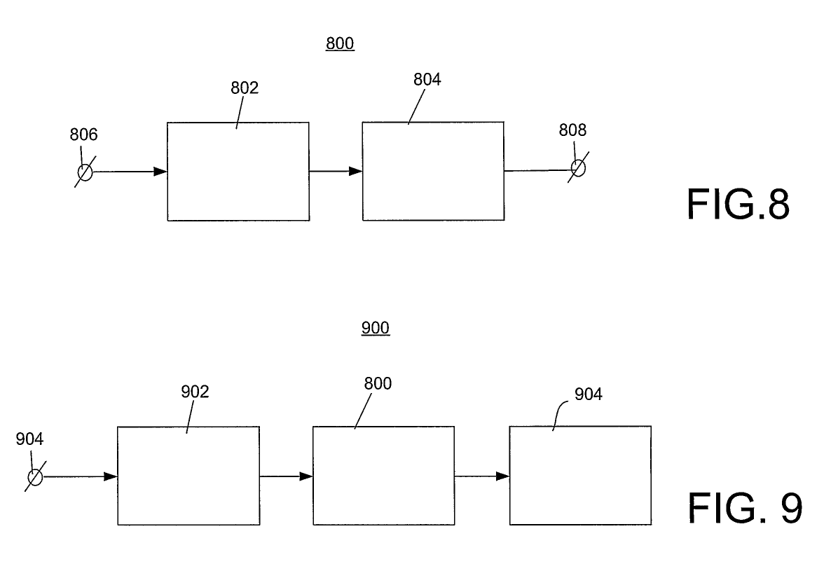

FIG. 8 schematically shows an interpolation unit according to the invention; and

FIG. 9 schematically shows an image processing apparatus according to the invention.

Same reference numerals are used to denote similar parts throughout the figures.

FIG. 1 schematically shows the effects of vertical averaging and edge directional averaging. FIG. 1a schematically shows an original image. FIG. 1b schematically shows an interlaced image which is based on that, i.e. only the odd/even video lines are remained for a predetermined interval of time. FIG. 1c schematically shows a first output image which is based on the interlaced image as depicted in FIG. 1b. The missing pixel values of FIG. 1b have been computed by means of a vertical averaging. As can be seen, a stair-case pattern is introduced by that. FIG. 1d schematically shows a second output image which is also based on the interlaced image as depicted in FIG. 1d. However, now the missing pixel values of FIG. 1b have been computed by means of edge directional averaging. That means that appropriate pixels have been selected for computing the missing pixel values. As can be seen now, the second output image and the original image are substantially mutually equal. This example demonstrates that by appropriate selection of input pixels, output pixels can be computed by means of interpolation, which resemble the optimal values relatively well. The interpolation unit according to the invention is arranged to determine appropriate input pixels by means of order statistical filtering a predetermined set of input pixels. Below, in connection with FIGS. 2-7 a number of these selections are explained in more detail.

FIG. 2 schematically shows a set of input pixels 101-114 of a single input image according to the invention. The set of input pixels comprises a first group of pixels and a second group of pixels. The pixels 101-107 of the first group of pixels are located on a first row of an input image. The pixels 108-114 of the second group of pixels are located on a second row of the input image. The set of input pixels is used to determine the value of the output pixel. The output pixel belongs to an output image and is located at a position in the output image which spatially corresponds with a point of intersection 100 in the input image. The point of intersection 100 is located where lines connecting pairs of input pixels being formed by respective input pixels of the first group of pixels and the second group of pixels intersect. For instance a first one 103 of the pixels of the first group forms a pair with a first one 112 of the pixels of the second group. These two pixels 103, 112 are connected by means of a first line 115. A further pair of pixels is performed by a second one 107 of the pixels of the first group and a second one 108 of the pixels of the second group. These two pixels 107, 108 are connected by means of a second line 116. In this case, as depicted in FIG. 2 the respective pixels of the pairs are located symmetrically around the point of intersection 100 of e.g. the first line 115 and the second line 116.

For each of the input pixels the corresponding weighting factor is provided in FIG. 2. For instance the weighting factor of the first one 103 of the pixels of the first group is equal to 3 and the weighting factor for the second one 108 of the pixels of the second group is equal to 1. To compute the value of the output pixel the following samples are used for order statistical filtering. The pixels of the first group and the second group having a weighting factor which is equal to 1, i.e. the pixels being referenced with reference numbers 101,102,106,107,108,109,113 and 114, are copied only once. The pixels of the first group of and the second group having a weighting factor which is equal to 3, i.e. the pixels being referenced with reference numbers 103,105, 110 and 112 are copied three times. The pixels of the first group and the second group having a weighting factor which is equal to 8, i.e. the pixels being referenced with reference numbers 104 and 112 are copied 8 times. That means that on basis of 14 input pixels a set is created having 36 samples (8*1+4*3+2*8). From this set of samples the value of the output pixel is determined on basis of an order statistical filtering. An example of such order statistical filtering corresponds to selecting a number of samples with central values. That means e.g. that 40% of the samples have a value which is below the values of the selected samples and that 40% of the samples have a value which is above the values of the selected samples. Subsequently, the value of the output pixel is computed by means of a weighted average of the selected samples.

Alternatively, a first order statistical filtering is applied to the first group of pixels and a second order statistical filtering is applied to the second group of pixels. Eventually, the outputs of these two order statistical filtering operations are combined to achieve the value of the output pixel.

FIG. 3 schematically shows an example of the selection of input pixels of three consecutive input images, according to the invention. The first group of pixels comprises a number of pixels 101-107 from the current image n, as described in connection with FIG. 2. The first group of pixels further comprises a number of pixels 201-207 of a previous image n−1. The second group of pixels comprises a number of pixels 108-114 from the current image n, as described in connection with FIG. 2. The second group of pixels further comprises a number of pixels 208-214 of a next image n+1. The weighting factors of the pixels of the previous image n−1 and the weighting factors of the next image are mutually equal: 1. The condition of having a point of intersection 100 of lines connecting respective pixels of pairs of pixels, is still valid. For instance a first one of the pixels 207 of the previous image n−1 which is connected with a first one of the pixels 208 of the next image, by means of a temporal interconnection line 215, form a pair. In this case, the point of intersection is located in a three-dimensional space, having two spatial dimensions and one temporal dimension.

Again, the value of the output pixel is determined, according to the invention, by means of the set of 28 pixels which are symmetrically disposed around a position in the input image which corresponds to a position in the output image. This the value of the output pixel is computed by means of order statistical filtering.

FIG. 4 schematically shows a selection of input pixels which is based on minimization of an error criterion. The set of input pixels comprises pixels from a previous image n−1, a current image n, and a next image n+1. The condition of having a point of intersection of lines connecting respective pixels of pairs of pixels, is still valid. The selection of pixels and order statistical filtering as described in connection with FIG. 4 is in particular relevant for de-interlacing. In the example as depicted in FIG. 4 there are two pixels 104,111 being selected from the current image n. These two pixels 104,111 are selected from rows which are located above and below the point of intersection 100, respectively. Preferably, the two pixels 104,111 have the same horizontal coordinate. Besides that, there are seven pixels 201-207 of the previous image n−1 used for evaluation of which finally a single pixel 203 is selected. These seven pixels 201-207 are located at the same row as where the point of intersection 100 is located. And there are seven pixels 208-214 of the next image n+1 used for evaluation of which finally a single pixel 212 is selected. These seven pixels 208-214 are also located at the same row as where the point of intersection 100 is located. The final output value of the output pixel is determined by computing the average of the output of two three taps median filters. The input of the first one of the median filters comprises the two pixels 104, 111 of the current image n and the selected pixel 203 of the previous image n−1. The input of the second one of the median filters also comprises the two pixels 104, 111 of the current image n and it further comprises the selected pixel 212 of the next image n+1.

The determination of the two selected pixels 203 and 212 is based on minimization of an error criterion. The two selected pixels are symmetrically located around the location of interpolation, i.e. corresponding to the position of the output pixel. The evaluation is performed by comparing a number of pairs of pixels. These pairs of pixels are all symmetrically located around the location of interpolation. Preferably, the evaluation is based on comparing the outputs of one or more of the two median filters. For example, the error criterion which is to be minimized comprises terms comprising the absolute difference between the outputs of the two median filters, whereby the median filters are provided with candidate pixels 201-207 and 208-214 of the previous image n−1 and the next image n+1. Alternatively, the error criterion comprises terms comprising the absolute differences between one of the median filters and the candidate pixel under consideration.

FIG. 5 schematically shows the selection of input pixels of a single input image, whereby a first distance 501 between a first input pixel 103 and the point of intersection 100 and a second distance 502 between a second input pixel 112 and the point of intersection are mutually different, whereby the second input pixel 112 is the counterpart pixel of the first input pixel 103. As described above, in connection with FIGS. 2-4 the input pixels are typically symmetrically located around the point of intersection. However, this is not necessary. In FIG. 5 is illustrated that, although the input pixels are located around the point of intersection 100 of connecting lines between respective pixels of pairs of pixels, the distances between selected pixels and the point of intersection are mutually different. Preferably, the selection weighting factors for both pixels of the pairs of pixels are mutually equal. The selection weighting factors depend on the respective distances to the point of intersection 100, as can be seen in FIG. 5.

FIG. 6 schematically shows an alternative selection of input pixels according to the invention. FIG. 6 clearly illustrate that the pixels of the first group of pixels are not necessarily located on a single row or column. In other words, the pixels of the first group of pixels may be spread in two spatial dimensions and also the pixels of the second group of pixels may be spread in these two spatial dimensions. The point of intersection 100 as depicted in FIG. 6 is surrounded by a number of input pixels 601-612. The value of the interpolated output pixel in the center is the central weighted median of the 12 weighted pixels 601-612 surrounding it. The weights given to the symmetrical pairs of pixels is determined by the absolute difference between the pixels in each pair and the relative distance to the point of intersection 100.

FIG. 7 schematically shows the selection of input samples whereby a number of input samples 701-704 are copies of input pixels and another number of input samples 705, 706 are computed by means of averaging further copies of input pixels. The value of the interpolated output pixel in the center is the central weighted median of the 6 weighted pixels surrounding it. The weights given to the symmetrical pairs of pixels is determined by the relative distance to the point of intersection 100, and is higher for original pixels 701-704 (the black ones) than for the interpolated ones 705, 706 (the gray ones).

FIG. 8 schematically shows an interpolation unit 800 according to the invention. The interpolation unit 800 comprises:

input pixel selection means 802 for selecting the input pixels, comprising a first group of pixels and a second group of pixels; and

order statistical filtering means 804 for determining the output pixel value on basis of the set of input pixels.

The interpolation unit 800 is provided with input images at its input connector 806 and is arranged to provide output images at its output connector 808. The interpolation unit 800 is arranged to select appropriate input pixels to create a set of samples for order statistical filtering. The set of samples is characterized in that lines connecting pairs of input pixels being formed by respective input pixels of the first group of pixels and the second group of pixels intersect at a position in the input image corresponding to a position in the output image where the output pixel is located.

Examples of creating a set of samples and of order statistical filtering are described in connection with FIGS. 2-7.

The input pixel selection means 802 and the order statistical filtering means 804 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 9 schematically shows an image processing apparatus 900 according to the invention, comprising:

receiving means 902 for receiving a signal representing input images;

the interpolation unit 800 as described in connection with FIG. 8; and

a display device 904 for displaying the output images of the interpolation unit 800. This display device 904 is optional.

The signal may be a broadcast signal received via an antenna or cable but may also be a signal from a storage device like a VCR (Video Cassette Recorder) or Digital Versatile Disk (DVD). The signal is provided at the input connector 904. The image processing apparatus 900 might e.g. be a TV. Alternatively the image processing apparatus 900 does not comprise the optional display device but provides HD images to an apparatus that does comprise a display device 904. Then the image processing apparatus 900 might be e.g. a set top box, a satellite-tuner, a VCR player or a DVD player. But it might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. An interpolation unit (800) for computing an output pixel value of an output pixel of an output image on basis of input pixel values of a set of input pixels (101-114) being selected from a number of input images, which is odd, the interpolation unit (800) comprising:
input pixel selection means (802) for selecting the input pixels, comprising a first group of pixels (101-107) and a second group of pixels (108-114), whereby lines (115,116) connecting pairs of input pixels (103,113) being formed by respective input pixels of the first group of pixels (101-107) and the second group of pixels (108-114) intersect at a position (100) in a particular input image, corresponding to a position in the output image where the output pixel is located; and
order statistical filtering means (804) for determining the output pixel value on basis of the set of input pixels (101-114).

2. An interpolation unit (800) as claimed in claim 1, whereby the order statistical filtering means comprises a central weighted median filter.

3. An interpolation unit (800) as claimed in claim 2, whereby a first one of the pairs of input pixels (104,111) which is located relatively close to said position (100) in the particular input image has a relatively high weight compared to a second one of the pairs of input pixels (101-114) which is located relatively far from said position (100) in the particular input image.

4. An interpolation unit (800) as claimed in claim 1, whereby the first group of pixels (101-107) are selected from a first row of the particular input image which is located above said position (100) in the particular input image and the second group of pixels (108-114) are selected from a second row of the particular input image which is located below said position (100) in the particular input image.

5. An interpolation unit (800) as claimed in claim 1, whereby the set of input pixels (101-114) comprises further input pixels (201-207) being selected from a previous input image (n−1) being temporally preceding the particular input image (n) and (208-214) from a next input image (n+1) being temporally succeeding the particular input image (n).

6. An interpolation unit (800) as claimed in claim 5, whereby the further input pixels (201-207) are selected from a first row of the previous input image (n−1) which corresponds to a third row in the particular input image (n) in which said position (100) is located and selected from a first row of the next input image (n+1) which corresponds to the third row in the particular input image (n).

7. An interpolation unit (800) as claimed in claim 6, being arranged to compute the output pixel value by computing an average of a first output of a first order statistical filter and a second output of a second order statistical filter.

8. An interpolation unit (800) as claimed in claim 7, whereby:
input of the first order statistical filter comprises a first one (104) of the pixels of the first group of pixels, a first one (111) of the pixels of the second group of pixels and a first one (203) of the pixels (201-207) of the first row of the previous input image; and
input of the second order statistical filter comprises the first one (104) of the pixels of the first group of pixels, the first one (111) of the pixels of the second group of pixels and a first one (212) of the pixels (208-214) of the first row of the next input image.

9. An interpolation unit (800) as claimed in claim 8, whereby the first one (203) of the pixels (201-207) of the first row of the previous image and the first one (212) of the pixels (208-214) of the first row of the next image are symmetrically located around said position (100).

10. An interpolation unit (800) as claimed in claim 7, whereby the first order statistical filter is a first three-tap median filter and the second order statistical filter is a second three-tap median filter.

11. An interpolation unit (800) as claimed in claim 10, whereby the first one (203) of the pixels (201-207) of the first row of the previous input image is selected on basis of minimization of an error criterion.

12. An image processing apparatus (900) comprising:
receiving means (902) for receiving an image signal representing images; and
an interpolation unit (800) for computing an output image on basis of input pixel values of a set of input pixels (101-114) being selected from a number of input images, which is odd, the interpolation unit as claimed in claim 1.

13. A method of interpolation by computing an output pixel value of an output pixel of an output image on basis of input pixel values of a set of input pixels (101-114) being selected from a number of input images, which is odd, the method comprising:
selecting the input pixels, comprising a first group of pixels (101-107) and a second group of pixels (108-114), whereby lines (115,116) connecting pairs of input pixels (103,113) being formed by respective input pixels of the first group of pixels (101-107) and the second group of pixels (108-114) intersect at a position (100) in a particular input image, corresponding to a position in the output image where the output pixel is located; and
determining the output pixel value by order statistical filtering the set of input pixels (101-114).

14. A computer program product to be loaded by a computer arrangement, comprising instructions to interpolate an output pixel value of an output pixel of an output image on basis of input pixel values of a set of input pixels (101-114) being selected from a number of input images, which is odd, the computer arrangement comprising processing means and a memory, the computer program product, after being loaded, providing said processing means with the capability to carry out:
selecting the input pixels, comprising a first group of pixels (101-107) and a second group of pixels (108-114), whereby lines (115,116) connecting pairs of input pixels (103,113) being formed by respective input pixels of the first group of pixels (101-107) and the second group of pixels (108-114) intersect at a position (100) in a particular input image, corresponding to a position in the output image where the output pixel is located; and
determining the output pixel value by order statistical filtering the set of input pixels (101-114).
